(19) United States
(12) Patent Application Publication
(10) Pub. No.: US 2024/0181464 A1
(43) Pub. Date: Jun. 6, 2024

(54) WETTING DEVICE FOR CEREAL GRAIN

(71) Applicant: SWISCA AG, Appenzell (CH)

(72) Inventors: Andreas Stöppler, Trogen (CH); Georg Stöppler, St. Gallen (CH)

(21) Appl. No.: 18/554,001

(22) PCT Filed: Apr. 1, 2022
(86) PCT No.: PCT/EP2022/058770

§ 371 Date: Oct. 5, 2023

(30) Foreign Application Priority Data
Apr. 8, 2021 (CH) 00361/21
Aug. 6, 2021 (CH) CH070139/2021

(51) Int. Cl. B02B 1/04; B02C 9/04

(52) U.S. Cl. CPC B02B 1/04; B02C 9/04

(57) ABSTRACT

A wetting device for cereal grain includes a container with a container inlet and a container outlet that are arranged such that cereal grain which flows into the container inlet gets to the container outlet due to the action of gravity. A plurality of nozzles serve for wetting the cereal grain in the inside of the container. The wetting device further includes a flow guidance device, for example formed by impact elements, in the inside of the container, by way of which flow guidance device a flow of cereal grain which flows into the container inlet and falls downwards is shaped. The nozzles are arranged such that liquid and/or steam which exits through them hits the cereal grain below the flow guidance device whilst the cereal grain is in freefall.

### BACKGROUND OF THE INVENTION

### Field of the Invention

The invention relates to a device for wetting cereal grain for the purpose of the subsequent further processing into a ground product.

### Description of Related Art

In mill facilities, cereal products are sprayed with water (humidified/wetted) for the subsequent processing. The wetting procedure is necessary, so that the grain husk detaches from the endosperm to an improved extent. By way of this, the milling becomes more uniform and the yield improves. According to the state of the art, herein and subsequent to a spraying, a best possible mixing of the cereal grain with water is achieved by way of mechanical processing, generally in a conveying screw. For this purpose, respective wetting devices in grain mills usually include horizontally lying rotation shafts with various mixing installations. The cereal grain flows continuously into this apparatus. At the same time, a defined water quantity is metered into this apparatus. The grain kernel is mixed with the free water by way of the rotating shafts and their stirring and mixing elements. Subsequently to the wetting, the cereal grain is conveyed into a so-called temper cell, where it is left to rest for some time, usually some hours, before it can be processed further.

Such wetting devices with regard to their function and their construction are not to be confused with cleaning facilities as are used in modern industrial mills in a preliminary process and which have the object of leading away contamination amongst the cereal grain, amongst other things by way of separating off cleaning water with the contamination which is dissolved therein.

In practice, apart from a good wetting characteristic, further functions are placed upon the important method step of the wetting in a grain mill. The germ contamination of the cereal due to field flora which inevitably enters the milling procedure by the grain mills is unavoidable. The interior of a wetting device provides the micro-organisms and germs with ideal breeding conditions for their growth. For this reason, the ability to clean the inside of the wetting device—as also the case with other devices of a mill facility—is an essential demand.

Wetting devices according to the state of the art have the disadvantage that mechanics for the mechanical mixing of the cereal grain are necessary, but are difficult to clean. In particular, the cleaning of the mixing elements and of the mixing space, in which elements and space moist and therefore correspondingly sticky cereal grain and further residue is constantly situated during operation, requires much effort and is therefore often disregarded.

### SUMMARY OF THE INVENTION

It is therefore an object of the present invention to provide a wetting method and a wetting device for cereal grain which overcome the disadvantages of the state of the art. The wetting device in particular should be simple in its construction and therefore entail a small as possible manufacturing and in particular maintenance expense. Additionally or alternatively to this, it should be easy to clean. The wetting method should be such that an accordingly simple as possible construction of the wetting device becomes possible.

The invention is based on the approach that a (defined) falling flow of cereal grain is generated in the inside of a container and that this cereal grain on falling is sprayed with a liquid and/or with steam (i.e., with water or water vapour and concerning water, enriched with additives in each case as required).

The temperature of the water during the spraying procedure can be set to an arbitrary value in accordance with requirements, i.e., between 0° C. and 100° C. The temperature and the pressure of the steam are likewise not set to a fixed operating point and can vary.

The fact that the cereal grain is sprayed and/or subjected to vapour “on falling” means that the liquid in the form of fine droplets or the steam hits the cereal grain whilst it is falling and not, for example, until the cereal grain has hit an underlay.

In contrast to a spraying of grain which is in a laying state or is being conveyed and/or mixed by way of mechanical means and which forms a mass of grain of grain kernels which are in contact with one another (bulk grain), essentially all the grain kernels come directly into contact with the wetting fluid (liquid and/or steam) already on being sprayed and/or subjected to vapour. For this reason, a subsequent mechanical through-mixing of the grain is not necessary. Mechanical mixers which require much effort to service and clean, such as for example conveying screws can be done away with. In contrast, the wetting device can be free of actively driven parts which are in contact with the cereal and move it mechanically.

The temperature of the water is between 0° C. and 100° C. during the spraying procedure. If the wetting is effected at least partly by steaming, then the temperatures and pressures of the steam are not fixed at an operating point and can likewise vary.

The mill facility can be constructed such that the cereal grain, under certain circumstances after a short sojourn time in the container but at all events without a subsequent mechanical through-mixing, gets from the wetting device into a temper cell in a direct manner, and specifically solely due to the effect of gravity if the temper cell lies below the wetting device, or merely by way of pneumatic means if it lies above the wetting device or at the same height.

The falling flow of cereal grain in particular can be curtain-like, locally extensive, i.e., form a flat contour in a horizontal section. In this manner, a wetting of essentially all the cereal grain kernels can be effected by way of a spraying or and/or steaming, for example from two sides.

In particular, the falling flow is vertical. This permits the falling flow to be particularly easily controllable, and specifically given a large grain throughout as well as if the grain throughput is smaller—the wetting functions without having to impart a horizontal impulse upon the grain kernels.

The spraying and/or steaming can be effected by way of suitably arranged nozzles. In particular, these can be arranged such that essentially the complete falling flow is wetted.

In particular, the falling flow can form a hollow cylinder, for example be essentially hollow circularly cylindrical with radially outwardly projecting leaf projections. Such a falling flow is star-shaped in the horizontal cross section, thus a circular ring with rays which project radially outwards therefrom and it therefore has a particularly large surface area for a simultaneous spraying and/or steaming from the inside as well as the outside.

Very generally, by way of the design of the flow guidance device with radially running segmenting elements, one can generate a falling flow which is segmented, for example by way of its forming radially running rays in the horizontal cross section. By way of this, the surface is particularly large and in particular nozzles which act from the outside and are distributed along the periphery of the container can wet in a particularly efficient manner by way of them being arranged, for example, in the circumferential direction (azimuthally) between the segments. For this purpose, at least three outer nozzles which are distributed along the circumference can be present, i.e., an outer nozzle is situated each at at least three different azimuthal positions. In particular, at least one outer nozzle can each be present per intermediate space between two outer (radial) impact elements.

The wetting device can include inner and outer nozzles independently of the precise shape of the falling flow. The inner nozzles can be arranged, for example, roughly on the axis of the container. The outer nozzles can be arranged for example at several planes along the container wall, for example on a feed conduit and form one or more horizontal, peripheral rings.

Such an arrangement with inner and outer nozzles has the advantage that the construction is particularly simple and that no elements which could potentially inhibit the falling flow project into this—the interior at the plane of the spraying can be completely free with the exception of centrally arranged inner nozzles and elements for their supply.

However, it is also possible to provide other arrangements of nozzles, for example on a frame which holds the nozzles at the positions which are optimised for the desired requirements.

The nozzles, in particular as the case may be the inner nozzles, however under certain circumstances also the outer nozzles can be designed as fan spray nozzles, in order to permit a relatively wide spraying angle.

In particular, the contoured falling flow is shaped by a flow guidance device which is arranged in the inside of the container, generally above the nozzles. A flow of cereal grain which gets into the container through an inlet—which in a conventional manner can be closable by way of an inlet slide or inlet flap—is shaped in the desired surface-optimising manner by way of the flow guidance device. The flow guidance device delays and shapes the vertical cereal grain flow in a manner such that a falling flow having a large surface area (lateral surface area) and being as easy as possible to wet arises. The falling flow is sprayed below the flow guidance device at a position at which the grain is in freefall.

The flow guidance device therefore subdivides the interior of the container into a collection region above the flow guidance device and a falling region below the flow guidance device.

For this reason, it can be the case that:
The grain is only sprayed whilst it falls downwards below the flow guidance device and not, for example, whilst it hits the flow guidance device or slides along this for some distance.
The grain is only deflected on a plane of the flow guidance device, and from there it drops through the inside of the container without being subjected to a further deflection. In contrast to arrangements with for example cascade-like guide surfaces, there can therefore be no spaces which are shielded by the flow guidance device, the cleaning of which requiring quite some effort. In particular, the wetting device can be designed such that the grain in freefall downwards from the flow guidance device can directly hit a container wall which delimits the container to the bottom or, depending on the throughput, grain which has already collected and piled up there, without yet further deflecting elements, screens or the like being present.

A buffer space can be formed below the collection region and the falling region, for example in a middle part of the container, subsequent to the falling region, wherein the falling region can merge into the buffer space without a clear delimitation being defined or visible. The container is delimited to the bottom by an outlet which can likewise be closable in a manner known per se by an outlet slide or an outlet flap.

Such a flow guidance device can first and foremost include a central impact element whose dimensions are matched to the inlet such that essentially all cereal grain kernels which flown in through the inlet hit the central impact element—or given an accumulation, the already accumulated cereal grain—and are prevented from falling downwards through the container directly from the inlet without being braked. Sometimes, the central impact element is dimensioned and arranged such that it lies below the inlet in the line of fall and covers the complete cross sectional area (in a projection along the vertical) of this. The upwardly pointing impact surface in particular can be convexly curved and for example be rotationally symmetrical about the vertical axis, in order to deflect of the cereal grain kernels uniformly to all sides.

The flow guidance device can furthermore include radially running, segmenting elements (outer impact elements) which in an outer region structure and segment the falling flow in the circumferential direction, so that the mentioned rays form in a horizontal cross section. These outer impact elements can furthermore be arranged in a manner ascending outwards, thus form a base which tapers downwards towards the axis and which is interrupted towards the centre and by intermediate spaces between the impact elements. For this reason, given a particularly large flow of cereal grain and an accumulation which is caused by way of this, the radius of the rays will automatically enlarge, which is why the flow guidance device acts in a self-regulating manner: given a larger flow of cereal grain, the lateral surface of the falling flow increases whilst the density of the cereal grain and the thickness of the falling flow contours remains the same and the efficiency of the wetting is not compromised.

In particular, the outer impact elements can have the shape of upwardly arched wings or ones which taper upwards towards an edge, the width of said wings increasing radially outwards and crest of which ascending radially outwards.

In particular, the impact elements are arranged in the wetting device such that they have no function which detaches the husk—i.e. the wetting procedure is effected in a gentle manner and the impact speed upon the impact elements—and also upon the collecting surfaces in the lower region of the wetting device, upon which the cereal grain falls after being wetted—are shaped and arranged such that the impact speeds of the cereal grain are accordingly moderate and indeed no mechanical processing of the cereal grain is effected.

In particular, the container can be cylindrical in regions, for example with a circular cross section. It can for example include a central cylindrical region, to which amongst other things the region in which the spray mist of the spraying liquid or steam hits the falling flow of cereal grain belongs. A conical inlet region and outlet region can be present each at the upper side and lower side respectively, said region continuously tapering towards the inlet and outlet respectively.

The inlet and/or the outlet can be arranged centrally, i.e., their respective middle axis can coincide with a (vertical) middle axis of the container. The vertical middle axis of the container in this text is sometimes simply denoted as “axis”.

Independently of the cross-sectional shape of the container, the wetting device can be designed such that there are no internal surfaces, on which the cereal grain kernels can remain clinging. In particular, the container therefore forms no surfaces which face upwards (shoulders or the like) and with the exception of the impact elements which includes for example only curved and/or inclined surfaces, no elements with further upwardly facing surfaces are present in the inside of the container.

However, one can optionally envisage the wetting device being controlled such that the wetted cereal grain is stowed for a brief period of time (typically a few seconds, for example 8-30s) in the lower part of the container. This—if required—can have a moisture-equalising effect, additionally to the moisture equalisation in the subsequently arranged temper cell.

The stowing in the lower part of the container can be effected with the help of an accumulation closed-loop control device (an accumulation closed-loop control element). Here, what is denoted by an “accumulation closed-loop control device” is a shut-off element which can be closed-loop controlled in the context of it not only being able to be switched between two states (“open” and “closed”), but permits the setting of different throughput quantities. Examples for such accumulation closed-loop control devices are accumulation closed-loop control flaps or outlet slides.

The accumulation closed-loop control device in particular is configured to closed-loop control the mass flow of grain of the wetted cereal grain in dependence on the accumulated level. In particular, an accumulation closed-loop control flap can be advantageous by way of such, under certain circumstances in contrast to an outlet slide, preventing the cereal grain from flowing out of the container in a non-symmetrical manner, so that there are regions in the accumulated product which sojourn for quite some time in the container and only a part mass flow falls out of the container. In an example, an accumulation closed-loop control flap with two (or possibly more than two) flap wings is used, the flap wings in the closed state each closing off a part-region of the flow cross section. By way of the use of several flap wings, a particularly uniform discharge of the cereal grain is ensured even with on only partial opening of the accumulation closed-loop control flap.

For the purpose of the closed-loop control of the accumulation, furthermore at least one level sensor can be present, by way of which the reaching of a level of a cereal grain level above the accumulation closed-loop control device can be determined. The at least one level sensor can permit a measurement of the level, or it can act in a discrete manner, i.e., for example determine the reaching of a certain predefined level. In both cases, a plurality of level sensors can also be present, wherein in the second case the various level sensors are attached such that they determine different level heights.

The accumulation closed-loop control device together with the at least one level sensor can be integrated into a control loop which by way of the setting of the throughput quantity by way of the accumulation closed-loop control device (given a accumulation closed-loop control flap, by way of the position of the flap or the flap wings) closed-loop controls the level in accordance with the specification, wherein the specification can be dependent on parameters (for example characteristics of the product, desired wetting, temperature etc,) and/or on settings carried out by the user.

An accumulation closed-loop control flap—or an outlet side—can be clamped between two fastening flanges, so that the flap or the slide can be disassembled at all times.

The provision of an accumulation closed-loop control device—in particular together with level sensors, in particular together with a closed-loop control as discussed here—is an option also for wetting devices very generally, i.e., wetting devices for cereal grain with containers (with a container inlet and a container outlet), and with at least one nozzle for wetting the cereal grain in the inside of the container.

The container can be for example of two parts, with a container upper part and a container lower part. The container upper part and container lower part can be fastened to one another via a flange connection. In particular, in embodiments in which a cleaning device is present, it is generally not necessary for the container upper part and container lower part to be separable from one another with little effort.

An optional, but often particularly advantageous cleaning device includes for example a plurality of cleaning spray balls and/or cleaning lances. Such cleaning spray balls or cleaning lances can be positioned in an unchangeable manner or, in particular in the case of cleaning lances, each include an element which can be extended into the interior of the container and which carries at least one cleaning nozzle. The cleaning lances can be designed such that an extension is effected automatically on account of the water pressure as soon as the cleaning lances are supplied with cleaning water. Alternatively to an automatic extension on account of the water pressure, a pneumatic actuation or another extension mechanism is also conceivable. A retraction after the cleaning has been effected can take place automatically, for example due to spring force or pneumatically.

A cleaning device of this type in particular can include possibly in each case at least one—generally a plurality, for example three—cleaning lance(s) or cleaning spray balls with cleaning nozzle(s) in the (upper) collection region and at least one—likewise generally a plurality, for example three—cleaning lance(s) with cleaning nozzle(s) in the falling region. Additional cleaning nozzles, possibly on additional cleaning lances can be provided, for example if the region below the flow guidance device has corresponding dimensions. The container and the cleaning device can be matched to one another such that an inner cleaning can be carried out without shadowed spraying regions.

The container can include a container emptying connection in a lower region. Such a container emptying connection can be closable in a manner known per se by way of an outlet ball cock or outlet flap. The cleaning agent (typically cold or hot water) is brought out of the container via the container emptying connection. Supplementarily or alternatively, the container emptying connection can be integrated into the outlet flap or the outlet slide and for example the outlet flap or the outlet slide can include an opening for residual cleaning water, said opening including for example a perforation, through which cleaning water can be led away.

In particular, the wetting device can include a (specially designed) outlet flap which can be switched between a closed and an open state and which in the closed state prevents cleaning fluid in the inside of the container from being able to flow through the container outlet but which includes a hollow shaft and an opening which in the closed state is open to the container inside, and which is connected to the hollow shaft. Given a closed outlet flap, cleaning fluid can then be discharged out of the inside of the container through the opening and the hollow shaft, without this flowing through the container outlet.

In particular, the cleaning is effected in operational pauses when no grain is fed to the wetting device. This means that the wetting device is configured not to deliver any cleaning fluid during the wetting operation when the wetting nozzles are in operation and the grain is fed through the container inlet. In contrast, the wetting device is configured to deliver fluid through the cleaning nozzles in a dedicated cleaning operation.

A cleaning device of the describe type with nozzles for spraying the container inner wall and/or other elements which are arranged in the inside of the container, said nozzles being arranged in the inside of the wetting device and/or being able to be extended into the inside of the wetting device—in particular together with an outlet flap of the mentioned type, through which cleaning fluid can be discharged—is one option also for wetting devices very generally, i.e. wetting devices for cereal grain with a container (with a container inlet and a container outlet), and with at least one nozzle for wetting the cereal grain in the inside of the container.

The wetting device is operated such that a wetting is effected with the desired fluid quantity. Thus, at no point in time is an excess of water fed, such an excess having to be separated out of the system again. For this purpose, a control—which belongs to the wetting device or to a superordinate unit, for example to the complete mill facility—can monitor the cereal grain throughput quantity as well as the quantity of sprayed-in fluid or steam and at least also meter in the latter. Herein, the metering-in is effected such that it is precisely that quantity which is desired in accordance with requirements which is metered in. This generally contributes to between 0.5% and 12% of the cereal quantity (in mass percent), and is therefore smaller in orders of magnitude than for example given cereal washers.

For determining the metering in accordance with requirements, a facility including the wetting device, apart from the wetting device can also include a measuring device for measuring the actual grain humidity of the respective cereal grain charge. Such a measuring device detects the moisture content of the cereal grain inline before the wetting procedure, by way of measuring apparatus (inline moisture sensors). For this, the control computes the necessary water wetting quantity.

Apart from the wetting device and the method for operating a wetting device, a mill facility also belongs to the subject matter of the present invention. Such a facility includes devices of the type known per se—for example a roller mill and sieve devices as well as weighing devices and/or metering devices and a conveying device—and additionally a wetting device of the type described here. Furthermore, a temper cell which is arranged subsequent to the wetting device can be present. The mill facility in particular can be designed such that no mechanical admixing of the cereal grain takes place and no mechanical conveying means with a physical contact with the cereal grain acts, between the wetting device and the temper cell—which does not rule out the presence of an optional pneumatic conveying (conveying in a gas stream).

### BRIEF DESCRIPTION OF THE DRAWINGS

Embodiment examples of the invention are hereinafter described by way of drawings. In the drawings, the same reference numerals denote the same or analogous elements. The drawings show elements which partly correspond to one another in dimensions which vary from figure to figure. There are shown in:

FIGS. 1 and 2 a wetting device in a perspective view and in a lateral view respectively;

FIG. 3 a view of the wetting device according to FIGS. 1 and 2, sectioned along the plane E-E in FIG. 2;

FIG. 4 a view of the wetting device according to FIG. 1-3, sectioned along a horizontal plane which lies above the impact elements;

FIG. 5 a view of the container upper part of the wetting device according to FIG. 1-4, sectioned along a vertical plane;

FIG. 6 a perspective view of the horizontal pipe, vertical pipe and central impact element of the wetting device according to FIG. 1-5;

FIG. 7 a schematic diagram of a wetting device with a temper cell;

FIGS. 8 and 9 a further wetting device in a perspective view and in a sectioned representation; and

FIGS. 10-12 details of the wetting device according to FIGS. 8 and 9.

### DETAILED DESCRIPTION OF THE INVENTION

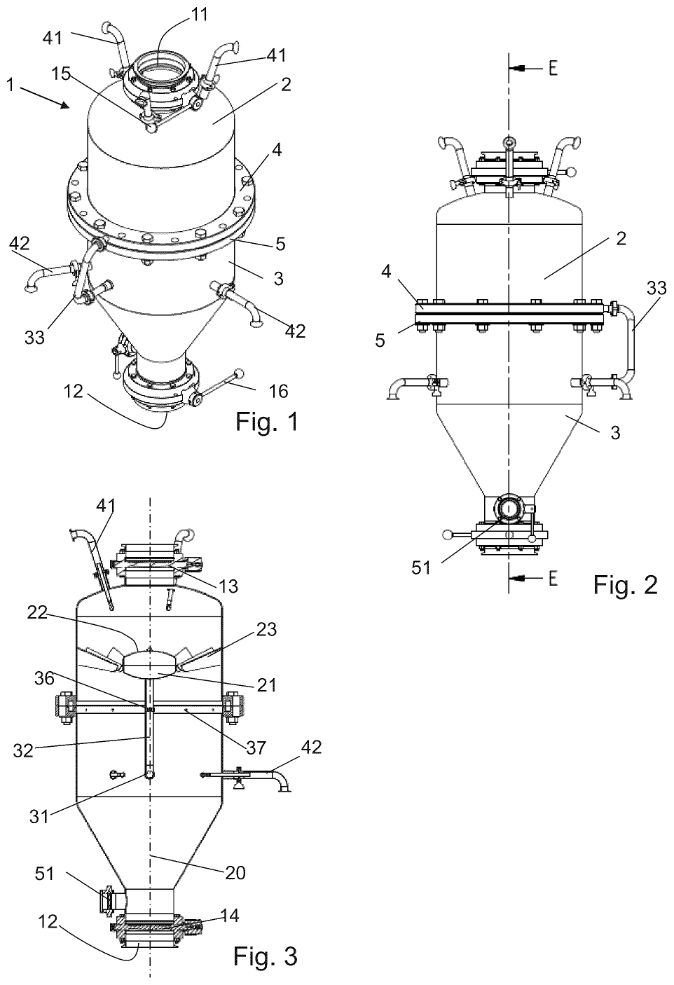

An example of a wetting device 1 is represented in FIG. 1 in a perspective view and in FIG. 2 in a lateral view. The wetting device includes a container which is formed by a container upper part 2 and a container lower part 3 which are connected to one another by way of a flange connection. The flange connection is formed by an upper flange ring 4 and a lower flange ring 5 which in the operationally ready state are screwed to one another. As is explained hereinafter, the flange connection does not need to be released for the cleaning of the wetting device.

The container upper part 2 forms the inlet 11, and the container lower part 3 forms an outlet 12 which for example are aligned to one another and are arranged below one another in a straight manner in a fall line. The inlet and outlet in the shown embodiment example are each arranged centrally, i.e., their vertical axis coincides with the axis of the container. They are generally formed such that a simple coupling to elements of a mill facility which are arranged upstream and downstream, for example containers, metering systems, pipe conduits etc. is possible. For this purpose, on the part of the inlet 11 or outlet 12, an inlet coupling structure and outlet coupling structure respectively (for example in each case a suitable connection stub) can be present. Furthermore, a closing inlet flap and outlet flap is present at the inlet and outlet respectively, or a suitable slide or another shut-off element. In the shown embodiment example, the inlet flap 13 and outlet flap 14 are each manually actuatable, with a suitable operating lever 15 and 16 respectively.

The container includes a container wall which is formed by the container upper part 2 and the container lower part 3 and which essentially forms a rotation body with a vertical axis 20. In a central region, the container wall is designed in a cylindrical manner and in a conical manner towards the inlet 11 and the outlet 12.

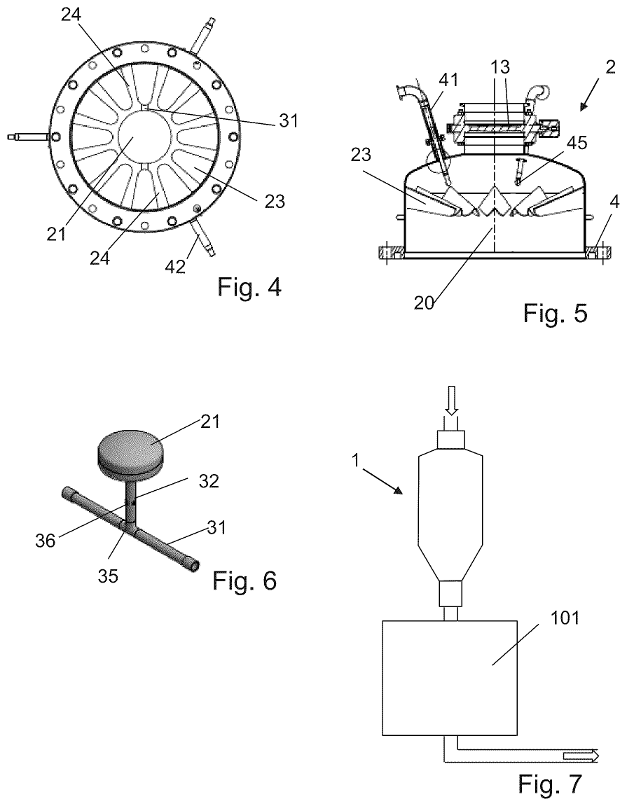

As one can see in FIG. 3, a central impact element 21 is arranged below the inlet 11. This forms an upwardly directed, convexly curved impact surface 22. Outer impact elements 23 which are also represented in FIGS. 4 and 5 are also present radially outside the central impact surface and are each designed in a roof-like manner by way of a pair of ramps and form a crest, said crest running radially and slightly ascending radially outwards and from which the descending ramp runs to both sides. As is particularly well visible in the plan view according to FIG. 4, the width of the impact elements increases radially outwards, so that the intermediate spaces 24 between them form radially running gaps whose width increases only slightly radially outwards and remains almost constant.

The wetting device furthermore includes a plurality of nozzles, through which the fluid is sprayed upon the falling cereal grain.

A first set of nozzles is formed by the inner nozzles 36, through which the fluid is sprayed radially outwards from a roughly axial position. The inner nozzles 36 apart from in FIG. 3 can also be seen in FIG. 6. The inner nozzles in the shown example are formed on a vertical pipe 32, into which the fluid from a horizontal pipe 31 gets. The vertical pipe also carries the central impact element 21 which for this reason and in the embodiment which is described here is fastened to the container lower part 3, in contrast to the outer impact elements which are present on the container upper part. The horizontal pipe 31 leads transversely through the container and carriers the vertical pipe 32. The horizontal pipe is supplied with the fluid from the one side via a container cut. A branching 35 for example is also located where the vertical pipe 32 is fastened. A part of the fluid is led from there, further through the horizontal pipe and at the side which lies opposite the container cut is led through a further container cur into a bow-like transition pipe 33 (FIG. 2) and from there to the nozzle ring of the outer nozzles 37. Other paths of the leading of the fluid to the nozzles are also possible, for example without a branching, wherein the fluid then for example goes upwards through the vertical pipe to the inner nozzles and from there in the inside of the vertical pipe goes downwards again, or with a transition between the inner and outer nozzles within the container instead of a transition pipe 33, with a leading of the fluid via the outer nozzles to the inner nozzles instead of vice versa, with separate fluid feed for the inner and outer nozzles, etc. Many further paths of the leading of the fluid to the nozzles are also conceivable.

The inner nozzles 36 are designed as fan jet nozzles which spray the fluid in a wide angle, so that the inner nozzles together form an annular region (ring diameter: somewhat larger than the diameter of the central impact element) around them in an essentially complete manner.

The outer nozzles 37 are arranged in a ring and spray from the outside to the inside. The outer nozzles too can be fan spray nozzles, wherein the spraying angle is for example less of a magnitude than with the inner nozzles. The azimuthal position of the individual outer nozzles can be matched to the respective position of the outer impact elements by way of each outer nozzle spraying a space which lies below the intermediate space in each case between adjacent outer impact elements and through which the downwardly falling cereal grain flows.

As with the inner nozzles 36, the outer nozzles 37 are also arranged roughly at the height of the flange connection between the container upper part 2 and the container lower part 3.

Cereal grain which is led from the inlet 11 into the wetting device falls onto the central impact element 21 and from there is deflected radially outwards. The flow of the grain is then segmented in an outer region by way of the outer impact elements 23. The flow of grain is therefore shaped by the intermediate space between the impact elements 21, 23. In a horizontal cross section, the flow has the shape of a ring with radially outwardly projecting rays, as one can see particularly well in FIG. 4; as a whole therefore a mass flow with a star-shaped cross section results. Herein, the ring as well as the rays are relatively thin, so that nowhere to a significant extent can cereal grain kernels be shielded from the nozzles by other cereal grain kernels.

The slight ascent outwards of the crests of the outer impact elements ensures a controlled distribution in the radial direction, even given the most varied of flow quantities and different speeds of the incident cereal grain which hits the central impact element. Given a larger mass throughput, a certain accumulation can also form. This is automatically controlled in that given a larger filling of the collection region above the impact elements, the cross section of the mass flow below the impact elements increases when more cereal grain is accumulated. This is effected automatically by way of the regions subjected to throughflow extending further radially outwards when more cereal grain is accumulated by the impact elements and the region which tapers slightly conically towards the middle begins to fill above the impact elements 21, 23. Hence it is ensured that even given a large mass throughput, the grain is always distributed such that it only forms very thin grain flow curtains. The spraying with the fluid therefore reaches essentially all cereal grain kernels independently of the mass throughput. Consequently, even given a large mass throughput, no mechanical mixing-in subsequent to the spraying is necessary.

Accordingly, the milling facility can be designed such that a temper cell 101 is directly subsequent to the wetting device 1, which is represented schematically in FIG. 7. The temper cell 101 can be arranged directly below the wetting device 1, or alternatively for example pneumatics which act directly upon the cereal grain (with at least one fan/compressor etc.) can transport the flow of cereal grain from the outlet of the wetting device to the inlet of the temper cell. At all events, generally no screw conveyor or the like is present between the wetting device and the temper cell, such requiring quite some effort in servicing and cleaning.

On operation of the mill facility, the cereal grain goes from a store through the wetting device into the temper cell and from there—after a suitable tempering time of a few hours which is selected in accordance with requirements, for example 8-16 hours—into the further elements of the mill, in particular roller mill, sieve devices etc.

An—optional—particularity of embodiments of the wetting device according to the invention is the presence of an integrated cleaning device. This includes a plurality of cleaning lances 41, 42, specifically a plurality of upper cleaning lances 41 for the space above the impact elements 21, 23 and a plurality of lower cleaning lances 42 for the space below the impact elements 21, 23. The cleaning lances each include a nozzle element which can be extended into the inside of the container and which is each with at least one cleaning nozzle. The extendable nozzle elements can optionally be designed such that they automatically extend inwards by way of the action of the water pressure, for example counter to a spring force, as soon as water is introduced into the cleaning lances. Their arrangement is such that given extended nozzle elements it is essentially the complete inside of the container which is sprayed when the cleaning water is introduced with sufficient pressure.

For the purpose of cleaning, for example at least the outlet flap is closed and water under pressure is led into the cleaning lances 41, 42, whereupon the nozzle elements extend, and the cleaning nozzles at the inner end of the nozzle elements spray cleaning water, by which means the complete insides of the container including the surfaces of the impact elements are sprayed. The cleaning water is discharged with the washed-away cereal grain residue via a—closable—container emptying connection 51 (outlet stub).

Even if the container emptying connection 51 is arranged directly above the outlet flap 14, a small quantity of residual water remains on the outlet flap 14 even after the emptying. Inasmuch as this water quantity is relevant to the user, the wetting device can be configured to also lead away this residual water quantity. For this purpose, for example a shaft which mounts the outlet flap or a wing of the outlet flap can be a hollow shaft with a perforation to the top. The residual water can then be led away through the hollow shaft.

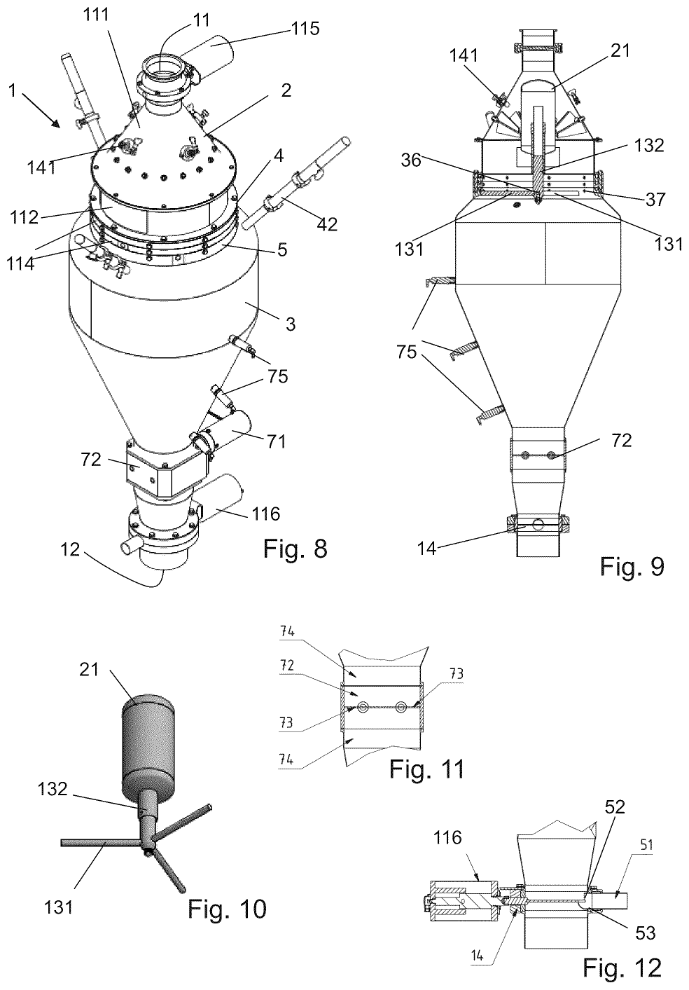

A further embodiment of a wetting device is represented in FIGS. 8 and 9. The manner of functioning of the flow guidance device with a central impact element 21 and outer impact elements 23 as well as the spraying is analogous to the embodiment of FIGS. 1-6.

The wetting device 1 of FIGS. 8 ad 9 is provided with a mechanism which permits a controlled accumulation of the wetted cereal grain in the container lower part, by which means if required a moisture equalisation between the cereal grain kernels can be effected. For this purpose, an accumulation closed-loop control flap 72 is present in the represented embodiment. A closed-loop control via an outlet slide would also be possible

A section through the accumulation closed-loop control flap 72 is shown in FIG. 11. In this representation, the closed-loop control flap is represented in the closed position. The accumulation closed-loop control flap 72 includes essentially identical, symmetrically arranged flap wings 73 (flap halves) which uniformly closed-loop control the entire mass flow of grain. The flap wings 73 are adapted to the contour and their position is set by way of a servomotor (servo actuation drive 72). On opening, the flap wings 73 rotate about their flap axes which are represented by concentric circles in the sectioned representation according to FIG. 11, from the horizontally closed position in opposite directions—depending on the opening to be set—by up to 90° downwards to the outlet.

By way of symmetrical position of the flap halves, a zone formation or an irregular mass flow of grain to the centre of the outlet is avoided.

The filling level of the container lower part is closed-loop controlled by way of level sensors 75 which detect the already wetted and accumulated product. For this purpose, the control (not shown in the figures) of the wetting device or of the superordinate unit includes for example a control loop which closed-loop controls the level in accordance with the specification by way of the position of the accumulation closed loop control flap 72.

The accumulation closed-loop control flap 72 in the represented embodiment example is clamped between two fastening flanges 74, so that the flap can be disassembled at all times—which however is not essential for the functioning of the accumulation closed-loop control flap 72.

On cleaning, the accumulation closed-loop control flap 72 is for example completely opened.

A further particularity of the embodiment of FIGS. 8 and 9 which is independent of the accumulation closed-loop control flap is the specially constructed outlet flap 14 which is designed specifically for wetting devices with a cleaning device and can generally be used in such (thus also in embodiments of the type which is represented in FIG. 1-6). In FIG. 8, a section through the outlet flap 14 is represented. With regard to the outlet flap 14, opposite to the drive side a hollow shaft 53 is the mounting shaft of the outlet flap 14 and is integrated directly on the flap, with an opening 52 to the top. The cleaning water as well as possible residual water then in the closed state of the outlet flap 14 can be led away through the hollow shaft which merges into a container emptying connection 51.

In normal operation of the wetting device, the outlet flap 14 is always opened and the outlet flap is only closed for the purposes of cleaning. In the opened state of the outlet flap, the entry of the hallow shaft is protected by a small pipe protrusion, so that no wetted cereal grain can enter out of the falling flow.

The embodiment of FIGS. 8 and 9, apart from the accumulation closed-loop control and the design of the outlet flap, in comparison to the embodiment of FIGS. 1-6 has the following differences/particularities which can be realised independently of one another and independently of the accumulation closed-loop control and the design of the outlet flap, i.e., in each case per se or in combination or in sub-combinations:
The container upper part 2 is of two parts and in the represented embodiment example is composed of an upwardly tapering first part 111 and of a second part 112 which is formed as a cylindrical intermediate piece.
Inner threads are located in the lower flange ring 5, which is why further nozzle rings 114—in the represented example it is two nozzle rings 114—can be clamped between the upper flange ring 4 and the lower flange ring 5. Herein, the lower flange ring 5 is fixedly connected to the container lower part 3.
Instead of the manual operating lever, the inlet flap 13 and the outlet flap 14 each include a pneumatic drive 115 and 116 respectively. The provision of a pneumatic drive only for an inlet flap or only for the outlet flap or the provision of an electromechanical drive for the inlet flap and/or outlet flap would be an option; in particular the inlet flap can also be configured to control a throughput quantity (concerning the outlet flap, this option in particular exists also when no separate accumulation closed-loop control flap is present, i.e. the outlet flap can then be a regulating flap for the closed-loop control of an optional accumulation function).
The central impact element 21 is held by three horizontal holding struts 131 which are fastened to the container lower part 3, and a vertical strut 132. One of the horizontal holding struts 131 is herein designed as a pipe, through which fluid gets to the inner nozzles 36. The inner impact element 21 with its holder is also represented in FIG. 10.
The inner nozzles 36 and the outer nozzles 37 in the first outer nozzle ring (in the lower flange ring 5) are always simultaneously supplied with fluid by way of a flexible or rigid connection, for the wetting application. Herein, the fluid can get directly into the horizontal holding strut which is designed as a pipe, for example through the first nozzle ring.
The vertical position of the inner nozzles 36 is located just below the (lowermost) outer nozzles 37 roughly at the height of the transition between the lower flange ring 5 and the remainder of the container lower part 3.
Instead of the upper cleaning lances 41, fixedly installed cleaning spray balls 141 are present and project into the inside of the container slightly above the outer impact elements 23. The manner of functioning of the lower cleaning lances 42 in contrast corresponds to that of the embodiment of FIGS. 1-6, i.e., on cleaning, water under pressure is led into the cleaning spray balls 141 and the cleaning lances 42, whereupon the nozzles of the cleaning spray balls 141 remain rigidly positioned and the nozzle elements of the cleaning lances extend.

Valid to all embodiments is: in the wetting device, the inner nozzles 36 or the outer nozzles 37 can be adapted to the product in the type of jet and the water throughput. In the simplest case, all outer nozzles are identical. The application region of the nozzles is optimised for a certain pressure range e.g., 3 bar-10 bar. In this pressure range, the water throughout is exactly specified. If more water throughput for the wetting procedure is necessary than is possible via the fixedly installed nozzles (in the represented examples the inner nozzles 36 and well as the outer nozzles 37 which are present in the container lower part 3), then the region for the water throughput can be increased by one or more additional nozzle rings 114 as is represented in an enlarged manner in FIGS. 8 and 9. The maximal number of additional nozzle rings is not limited. The additional nozzle rings 114 can be supplied separately with water in an external manner. The construction of the additional nozzle rings is represented identically in FIGS. 8 and 9.

1. A wetting device for cereal grain,
comprising a container with a container inlet and a container outlet which are arranged such that cereal grain which flows into the container inlet gets to the container outlet due to the action of gravity, wherein the wetting device comprises a plurality of nozzles in order to wet the cereal grain in an inside of the container, further comprising a flow guidance device in the inside of the container, by way of which a flow of cereal grain which flows into the container inlet and falls downwards is shaped, wherein the nozzles are arranged such that liquid and/or steam which exits through them hits the cereal grain below the flow guidance device whilst the cereal grain is in freefall.

2. The wetting device according to claim 1, wherein the flow guidance device comprises a central impact element, upon which cereal grain which flows in through the container inlet hits, and which deflects the cereal grain onwards.

3. The wetting device according to claim 1, wherein the flow guidance device comprises a plurality of outer impact elements, by way of which the flow of cereal grain which falls downwards from the flow guidance device is segmented at least in regions.

4. The wetting device according to claim 3, wherein the outer impact elements are arranged in a manner ascending outwards.

5. The wetting device according to claim 1, wherein the flow guidance device defines a throughflow cross section area which comprises a central ring and rays running radially outwards therefrom.

6. The wetting device according to claim 1, wherein the nozzles comprise inner nozzles with a spray direction from the inside to the outside, as well as outer nozzles with a spray direction from the outside to the inside.

7. The wetting device according to claim 6, wherein the inner nozzles are arranged on a holder of a central impact element and/or the outer nozzles are arranged along the circumference of a regionally circularly cylindrical container wall of the container.

8. The wetting device according to claim 1, wherein at least some of the nozzles are designed as fan jet nozzles.

9. The wetting device according to claim 1, wherein the container is free of inner horizontal surfaces below the container inlet, on which surfaces cereal grain could remain lying.

10. The wetting device according to claim 1, which is free of elements which move during normal usage.

11. The wetting device according to claim 1, comprising a plurality of cleaning nozzles through which a cleaning fluid can be introduced into the container, in order to rinse away surfaces of the container wall as well as of the flow guidance device.

12. The wetting device according to claim 11, comprising a plurality of cleaning spray balls and/or a plurality of cleaning lances with a nozzle element which can be extended into the container inside and is each with at least one of the cleaning nozzles.

13. The wetting device according to claim 11, wherein the cleaning nozzles comprise upper cleaning nozzles which are arranged above the flow guidance device, and lower cleaning nozzles which are arranged below the flow guidance device.

14. The wetting device according to claim 1, comprising an accumulation closed-loop control device which is arranged below the flow guidance device and through which a flow of the cereal grain through the container outlet can be closed-loop controlled.

15. The wetting device according to claim 14, comprising at least one level sensor, by way of which the reaching of a level of a cereal grain level above the accumulation closed-loop control device can be determined, for the closed-loop control of a throughput quantity through the accumulation closed-loop control device.

16. The wetting device according to claim 14, wherein the accumulation closed-loop control device is an accumulation closed-loop control flap with at least two flap wings.

17. The wetting device according to claim 1, further comprising an outlet flap with a hollow shaft that is connected to at least one opening, said opening in a closed state of the outlet flap being open to the inside of the container, wherein given a closed outlet flap cleaning fluid can be led away out of the inside of the container through the opening and the hollow shaft without this flowing through the container outlet.

18. A mill facility, comprising a wetting device according to claim 1, as well as a temper cell, wherein the temper cell is arranged such that the cereal grain goes from the outlet of the wetting device into the temper cell in a direct manner without mechanical processing means which lie therebetween.

19. The mill facility according to claim 18, further comprising a grinding unit, in particular with a roller mill and sieve devices, which is arranged downstream of the temper cell.

20. The wetting device according to claim 1, further comprising a control for metering the fluid in dependence on a measured humidity of the cereal grain.

21. A method for operating a wetting device for cereal grain according to claim 1, wherein the wetting device comprises a container, and the cereal grain which flows in via a container inlet gets to the container outlet due to the effect of gravity, wherein the cereal grain on falling is sprayed with a liquid and/or with steam.

22. The method according to claim 21, wherein a contoured falling flow of the cereal grain is generated in the container and the cereal grain in this contoured falling flow falls downwards whilst it is sprayed with liquid or the steam.

23. The method according to claim 21, wherein a quantity of liquid or steam is closed-loop controlled such that the mass represents between 0.5% and 12% of a mass of the sprayed cereal grain.

24. The mill facility according to claim 18, comprising a control for metering the fluid in dependence on a measured humidity of the cereal grain.
